(19) United States
(12) Patent Application Publication
(10) Pub. No.: US 2025/0119393 A1
(43) Pub. Date: Apr. 10, 2025

(54) CONGESTION MITIGATION IN INTERCONNECTION NETWORKS

(71) Applicant: Intel Corporation, Santa Clara, CA (US)

(72) Inventors: Hossein FARROKHBAKHT, Toronto (CA); Fabrizio PETRINI, Menlo Park, CA (US)

(21) Appl. No.: 18/980,838

(22) Filed: Dec. 13, 2024

(51) Int. Cl. H04L 49/253; H04L 49/112

(52) U.S. Cl. CPC H04L 49/254; H04L 49/112

(57) ABSTRACT

Examples described herein relate to switch circuitry that is to: based on receipt of a packet at the first input port and based on allocation of a first memory region in the memory to the first input port: based on capability of a first buffer for the first output port to store the packet, store the packet into the first buffer and egress the packet from the first buffer to the first output port and based on incapability of the first buffer to store the packet, store the packet into the first memory region and associate the packet with the first buffer prior to egress from the first output port.

### BACKGROUND

Networks provide connectivity among multiple processors, memory devices, and storage devices. Some networks utilize virtual channels (VCs) to provide performance improvement by mitigating the impact of head-of-line (HoL) blocking. HoL blocking occurs when a first packet at the head of a single VC cannot make forward progress because its output port is held by a second packet so that the first packet cannot traverse the router due to waiting for the head of the VC to clear.

### BRIEF DESCRIPTION OF THE DRAWINGS

FIG. 1 depicts an example switch.

FIG. 2 depicts an example switch system.

FIG. 3 depicts an example of output port arbitration.

FIG. 4 depicts an example of arbitration.

FIG. 5 depicts an example of an arbiter.

FIG. 6 depicts an example of an arbiter.

FIGS. 7A-7K depict example operations.

FIGS. 8A and 8B depict example processes.

FIG. 9 depicts an example switch.

FIG. 10 depicts an example system.

### DETAILED DESCRIPTION

A network on chip (NoC) design can provide a cornerstone of correctness by being free of deadlock. For an interconnection network, correctness can include a guarantee of delivery of a transmitted packet to a destination receiver. An interconnect design ensures correctness by preventing deadlock, which occurs when a group of agents that share some resources remain in a perpetual waiting state due to a circular dependency. In an interconnect of a large-scale system, the agents are packets, and the resources are buffers that store incoming packets as they traverse the network to reach the destinations. The interconnection network can experience routing-level deadlock in which packets cease to progress and cause the system to malfunction. To achieve deadlock-free communication, some trade-offs are involved, such as virtual channels, performance issues and/or hardware complexity.

A routing-level deadlock can arise where multiple packets are held in buffers while waiting for other held buffers to become free. As packets do not release from the buffers that they are occupying, other packets can wait indefinitely, resulting in a routing-level deadlock. To this end, multiple VCs per message type can be used to provide routing-level deadlock freedom. The number of VCs to provide correctness can be based on factors such as topology and routing scheme. Unfortunately, VCs are limited resources as their implementations utilize a large number of flipflops or static random access memory (SRAM), which consume power and resources.

Various examples can potentially reduce HoL blocking for an input port by: accessing a memory region allocated for the input port and bypass buffers allocated per output port. A linked-list can be used to track flits (e.g., packets) stored in the memory region for the input port. The bypass buffer can be implemented as a first in first out (FIFO) buffer, in some examples. Arbiters can receive packets from bypass buffers of different input ports to select a packet to egress from an output port. Output port credit signals can be fed to the output stage, eliminating the credit propagation to the input stage. A selected winner packet from an input port may not block packets addressed to other output ports if no credit is available for the packets addressed to other output ports.

Various examples can apply to different topology types; apply to high-radix and low-radix routers; apply to various protocol models and shared memory protocol and Ethernet protocol; apply to different routing schemes; or reduce the number of wiring at the output stage of the router. Compared to a multi-VC designs, various examples can significantly reduce the number of wirings and cell count, and improve throughput by eliminating the HoL blocking.

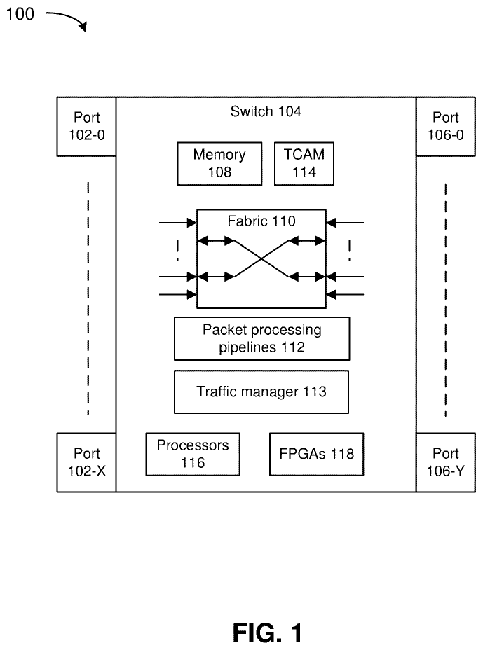

FIG. 1 depicts an example system. The router can be used in a network on chip (NoC), mesh, or off-chip networking environments. Various examples of switch 100 can be used to utilize a bypass buffer for a particular output port to buffer packets before arbitration to egress from the output port, as described herein. Switch 104 can route packets, flits, or frames of any format or in accordance with any specification from any port 102-0 to 102-X to one or more of ports 106-0 to 106-Y (or vice versa). One or more of ports 102-0 to 102-X can be connected to a network of one or more interconnected devices. Similarly, one or more of ports 106-0 to 106-Y can be connected to a network of one or more interconnected devices.

In some examples, switch fabric 110 can provide routing of packets from one or more ingress ports for processing prior to egress from switch 104. Switch fabric 110 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 108 can be configured to store packets received at ports prior to egress from one or more ports. Packet processing pipelines 112 can include ingress and egress packet processing circuitry to respectively process ingressed packets and packets to be egressed. Packet processing pipelines 112 can determine which port to transfer packets or frames to using a table that maps packet characteristics with an associated output port. Packet processing pipelines 112 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 112 can implement access control list (ACL) or packet drops due to queue overflow. Packet processing pipelines 112, processors 116, and/or FPGAs 118 can be configured to determine store packets in a bypass buffer or input memory, as described herein.

Configuration of operation of packet processing pipelines 112, including its data plane, can be programmed using Programming Protocol-independent Packet Processors (P4), C, Python, Broadcom Network Programming Language (NPL), or x86 compatible executable binaries or other executable binaries.

Traffic manager 113 can perform hierarchical scheduling and transmit rate shaping and metering of packet transmissions from one or more packet queues. Traffic manager 113 can perform congestion management such as flow control, congestion notification message (CNM) generation and reception, priority flow control (PFC), and others.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

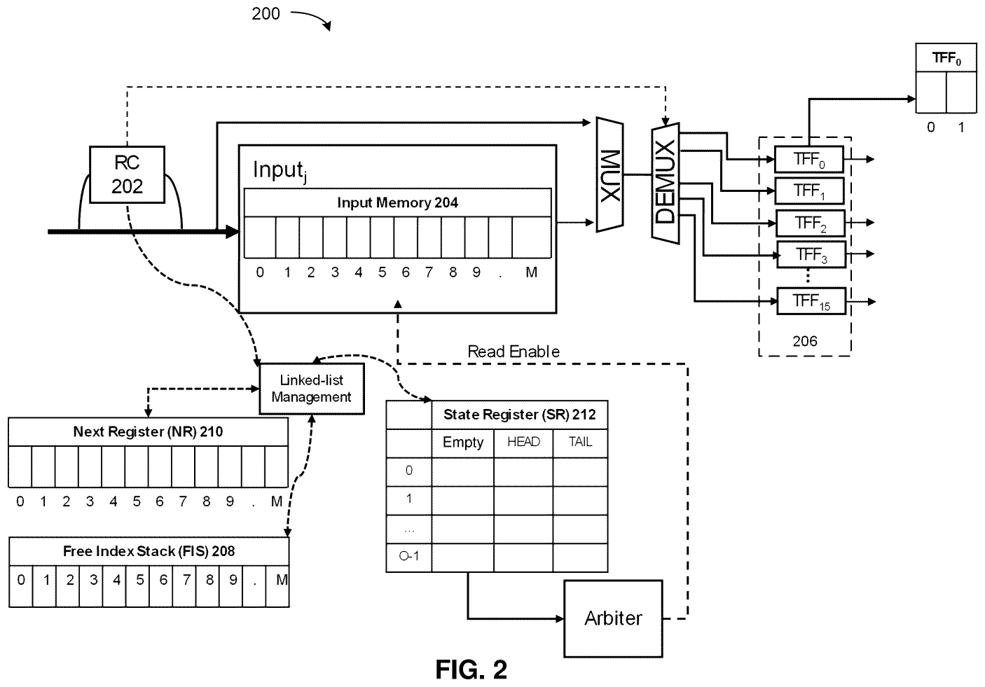

FIG. 2 illustrates an example system. For simplicity of description, one input port and one output port are represented. However, the system can be utilized for multiple input ports that provide packets to multiple output ports. Based on receipt of a packet, route compute (RC) unit 202 can determine an output port based on source and destination information in the packet header and routing configuration. A port identifier (ID) associated with the selected output port can be used to select a row number in state register (SR) 212 from which to access an entry for the output port. RC unit 202 can determine whether to store a packet received in a memory slot in input memory 204 or in bypass buffer 206 allocated to the selected output port for the packet based on availability in bypass buffer 206.

For an input port, O number of bypass buffers 206 (e.g., Tree Flit FIFO (TFFs)) can be used, where O represents a number of output ports. For example, RC 202 can direct a packet to bypass buffer 206 when bypass buffer 206 is not full and otherwise direct the packet to input memory 204 to store the packet when bypass buffer 206 is full. Based on availability to store a packet in a buffer 206, RC 202 can cause a packet to traverse a bypass path to buffer 206 for the output port for the packet. For example, an incoming packet flit can bypass input memory 204 if the corresponding linked list an entry in SR 212 is empty and the corresponding buffer 206 has free space. In this example, a bypass buffer 206 for an output port stores 2 packets, but other numbers of packets can be stored in bypass buffer 206.

Input memory 204 can be allocated to store multiple different types of packets (e.g., request (e.g., load or store), response (e.g., load response of data), or others), and different message types can occupy a certain number of entries in input memory 204 to reduce a likelihood of protocol-level deadlock or HoL blocking among different types of messages. The number of entries per message type can be based on the round-trip latency between the routers. For example, N counters can be used to track the number of available slots in input memory 204, where N is the number of message types. Use of a single memory region 204 per input port can allow for no VCs per input port or a single VC per input port.

Various examples can utilize Free Index Stack (FIS) 208 and Next Register (NR) 210 to track available regions in input memory 204 and utilize state register (SR) 212 to track packets available for an output port. For example, FIS 208 can include a register that tracks free entries in memory 204. In some examples, a single FIS 208 can be utilized per input port so that different instances of FIS 208 can be utilized for different input ports. However, a single instance of FIS 208 can be utilized for multiple input ports. FIS 208 can be implemented as a free linked list and can receive a 1 pop and 1 push request per clock cycle, and returns a free slot in memory 204 in a single clock cycle. For example, NR 210 can include a register that is to store an indicator of a next available entry in memory 204.

For example, SR 212 can track a number of packets addressed to one or more output ports for a particular input port. An SR can be allocated per input port and/or per message type. A number of rows in SR 212 can represent a number output ports in the router. A row can be allocated to a single output port so that the row tracks the packets destined for the output port. In other words, rowᵢ of the SR 212 can track of the packets to be egressed from output portᵢ. An entry in rowᵢ in SR 212 can include the following fields: empty field, head pointer to the next pointer in NR 210, and a tail pointer to a last pointer in the NR 210. The empty field can indicate if a linked list for an output port is empty or not empty. In other words, the empty field can indicate if there are any packets from an input port destined for the corresponding output port. When the empty field of a row is 1, the list is empty and no packets are destined for the corresponding output port.

A packet may be used herein to refer to various formatted collections of bits that may be sent across a network, such as Ethernet frames, Internet Protocol (IP) packets, Transmission Control Protocol (TCP) segments, User Datagram Protocol (UDP) datagrams, etc.

A flow can include a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination UDP ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

In some examples, switch 200 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, network interface device, switch, router, and/or receiver network interface device can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, router and switch can be used interchangeably. In some examples, a forwarding device can include a router and/or switch.

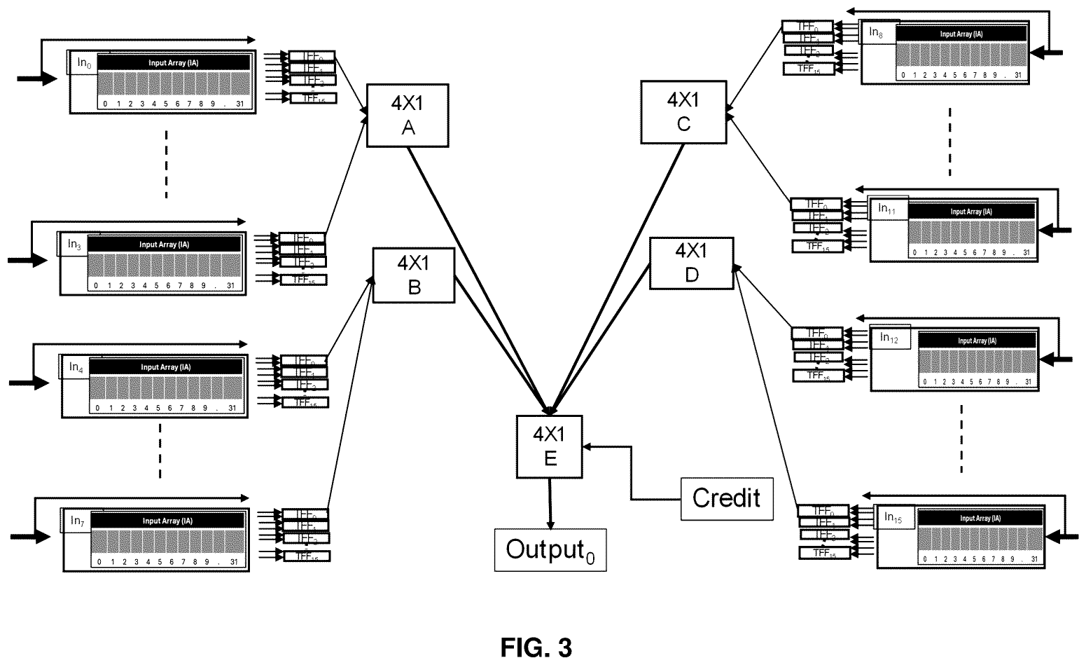

FIG. 3 depicts an example of arbitration to an output port. In this example, 16 input ports can utilize 16 bypass buffers for 16 output ports. In some examples, multiple level arbitration can be utilized. For example, a first arbiter (A) can be assigned to arbitrate a first set of 4 input ports, a second arbiter (B) can be assigned to arbitrate a second set of 4 input ports, a third arbiter (C) can be assigned to arbitrate a third set of 4 input ports, and a fourth arbiter (D) can be assigned to arbitrate a fourth set of 4 input ports. Such multiple level arbitration configuration can reduce a number of wires utilized to couple input ports to an output port.

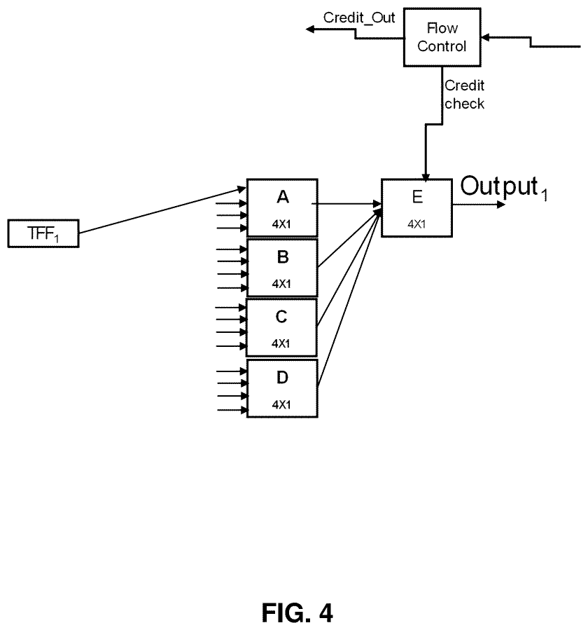

FIG. 4 depicts an example of output port arbitration. In some examples, multiple level arbitration can be utilized. As mentioned, N number of counters per output port can track the availability slots in an Input Memory for an input port. Credit signals can be asserted corresponding to a message type and the corresponding upstream counter is incremented by 1 based on the flit skipping the Input Memory to a bypass buffer or when the packet is read from the Input Memory to be written into the corresponding bypass buffer. If an incoming flit can skip the Input Memory while another flit (e.g., same message type) is read from the memory, the corresponding upstream counter can be incremented by 2. The credit signals can be fed to the output stage E, and credit propagation to the input stage may not occur. Compared to a multi-VC design, examples can reduce the number of wirings and cell count, while improving throughput by eliminating the HoL blocking.

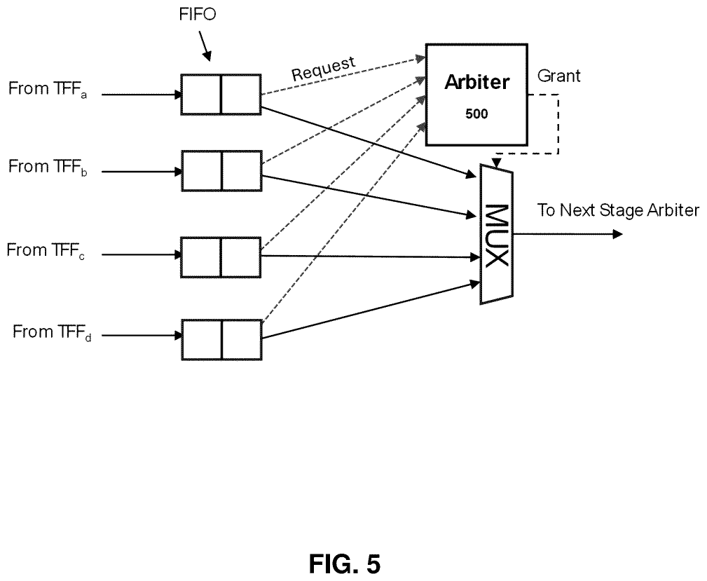

FIG. 5 depicts an example of an arbiter. Arbiter 500 can represent arbiter A, B, C, or D. Requests can be issued from bypass buffers of a group of 4 input ports to arbiter A. Similarly, requests can be issued from bypass buffers of a second group of 4 input ports to arbiter B; requests can be issued from bypass buffers of a third group of 4 input ports to arbiter C; and requests can be issued from bypass buffers of a fourth group of 4 input ports to arbiter D. Arbiter 500 can select a flit to forward to a next arbiter (e.g., arbiter E) by round robin, weighted round robin, or other schemes. Arbiter 500 can cause multiplexer (MUX) to select a packet to forward based on selection of the flit to forward.

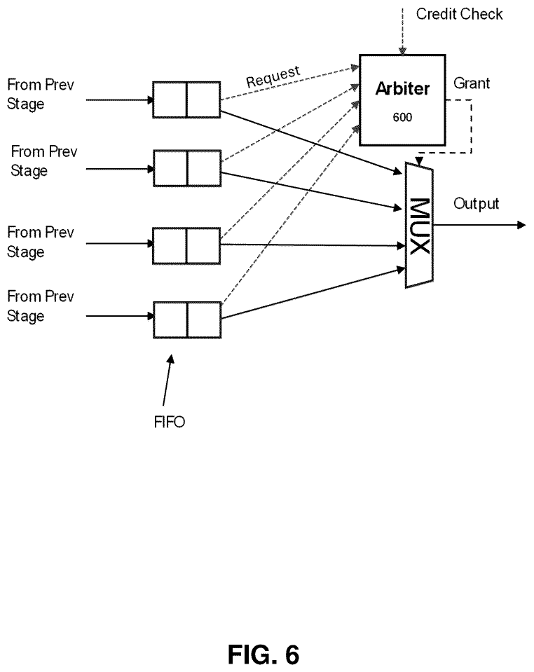

FIG. 6 depicts an example of an arbiter. Arbiter 600 can receive inputs of selected flits from an instance of arbiter 500 of stages A-D and select a flit to output from an output port by round robin, weighted round robin, or other schemes.

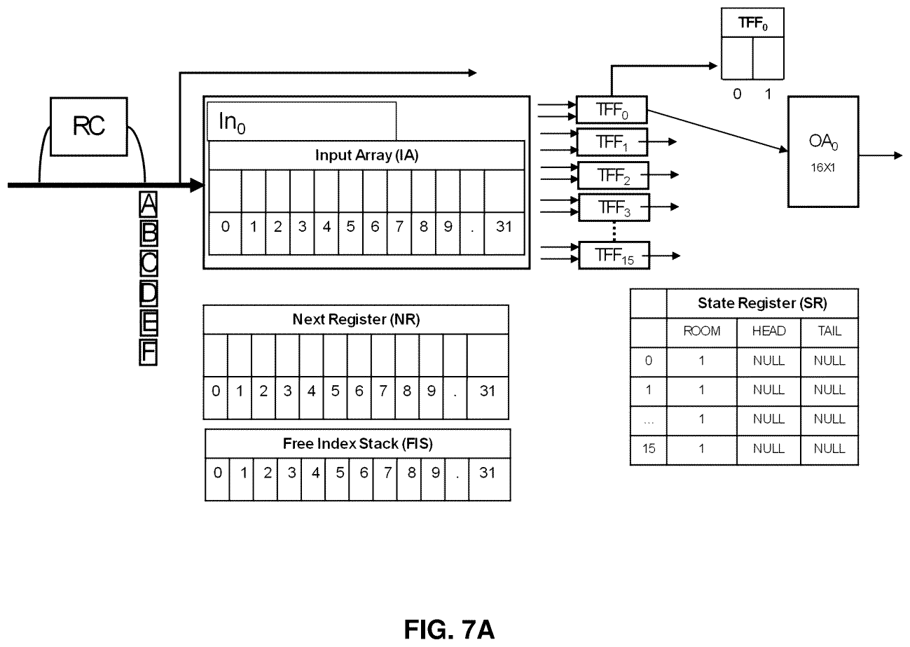

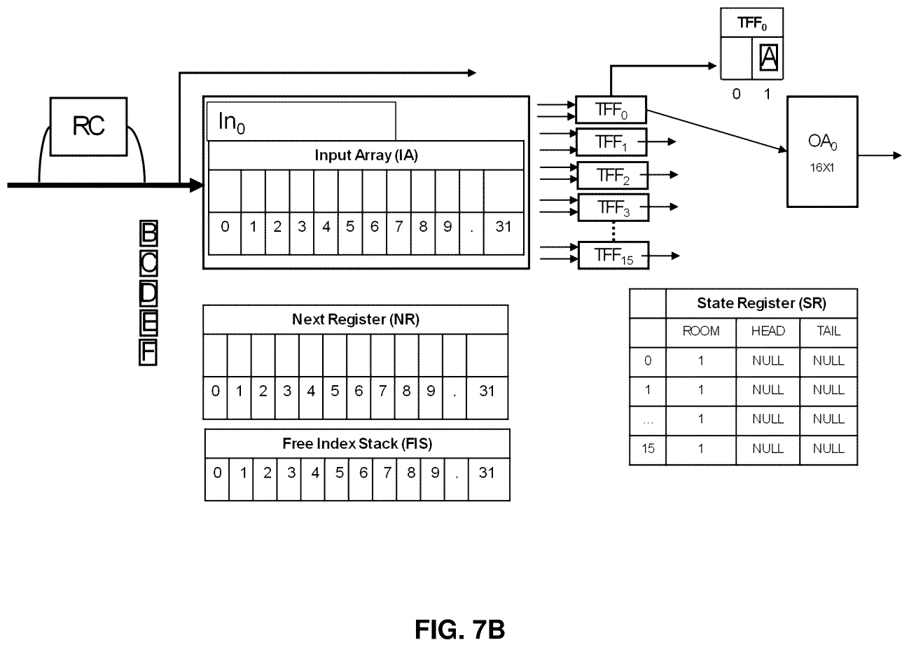

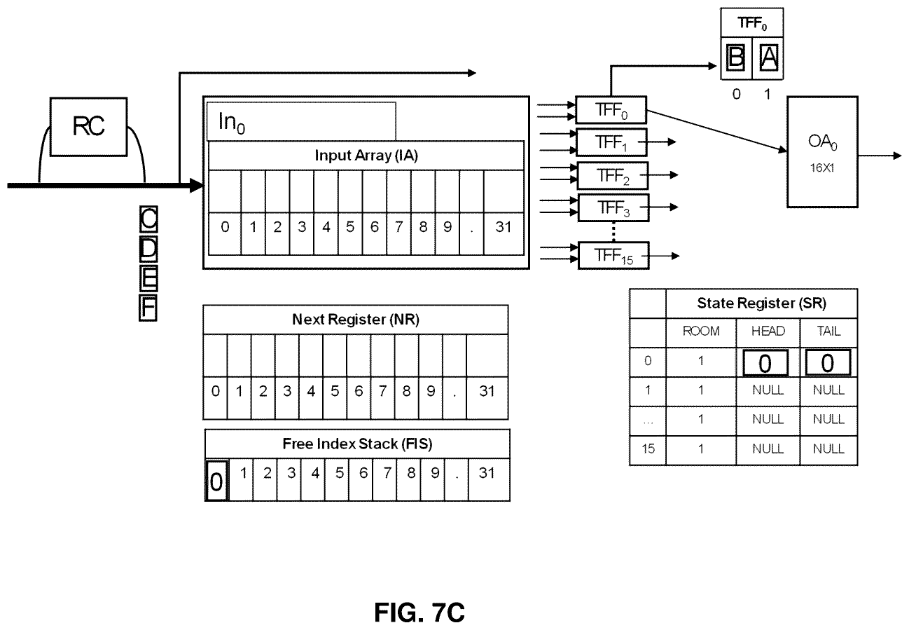

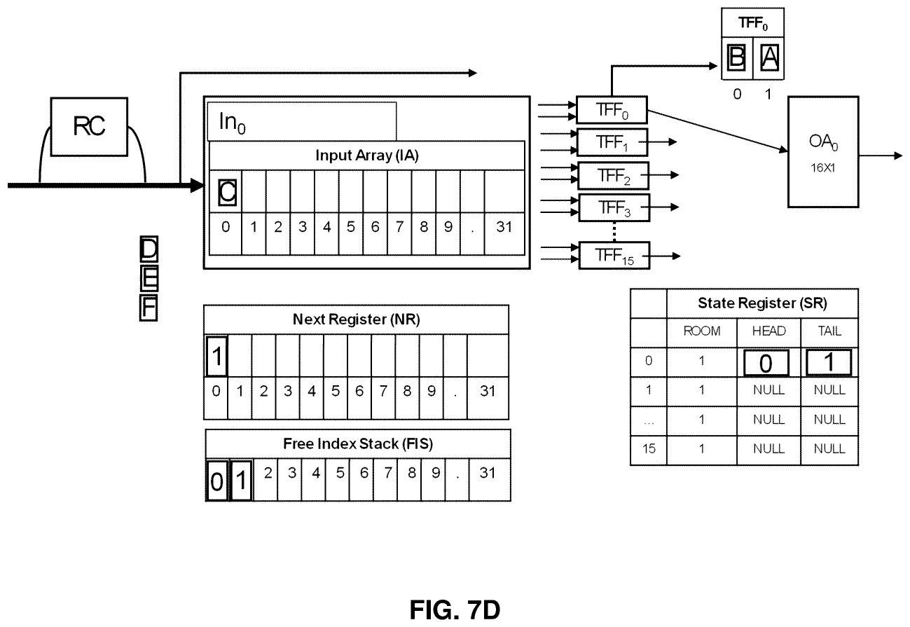

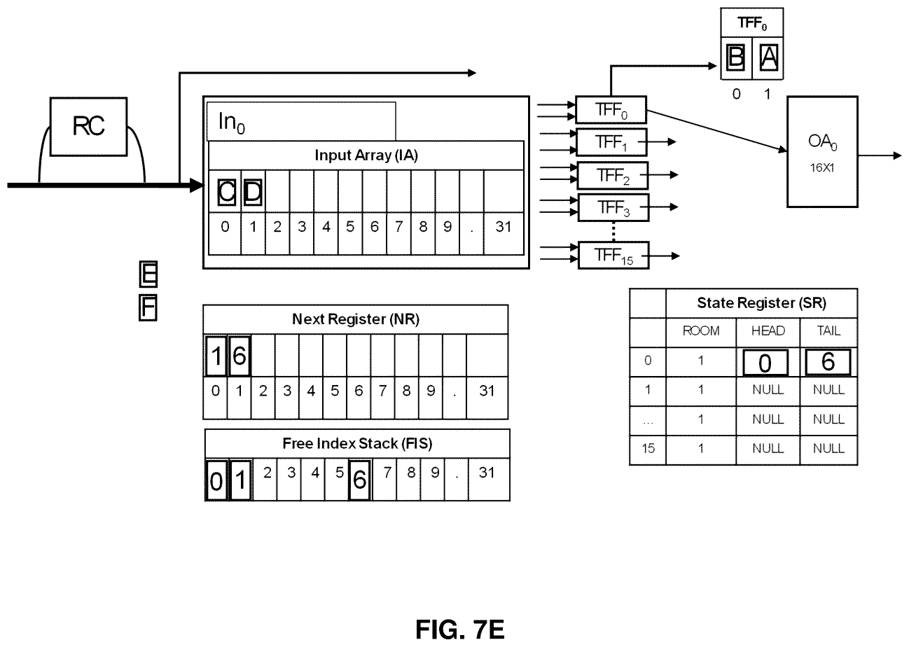

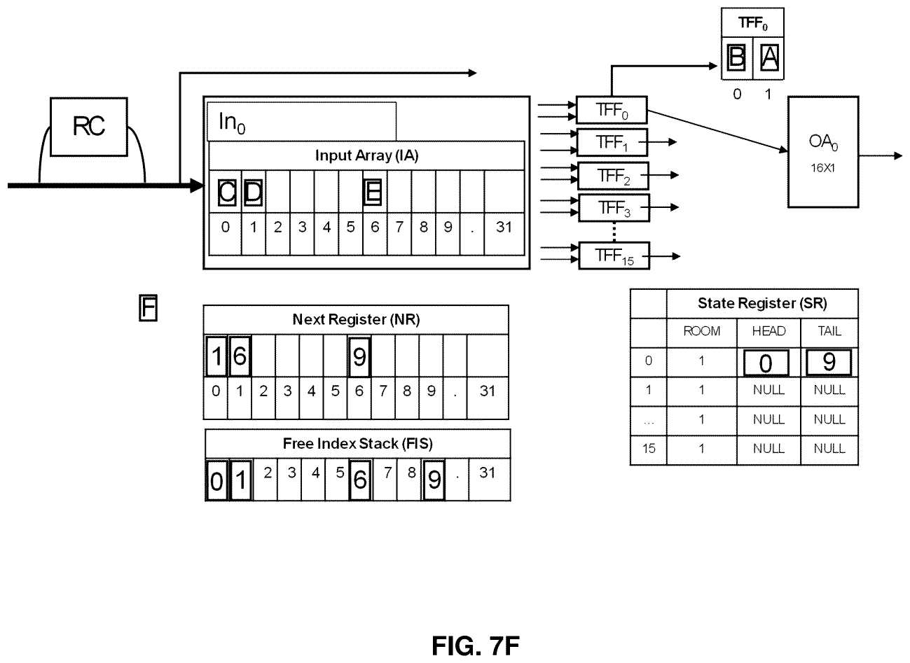

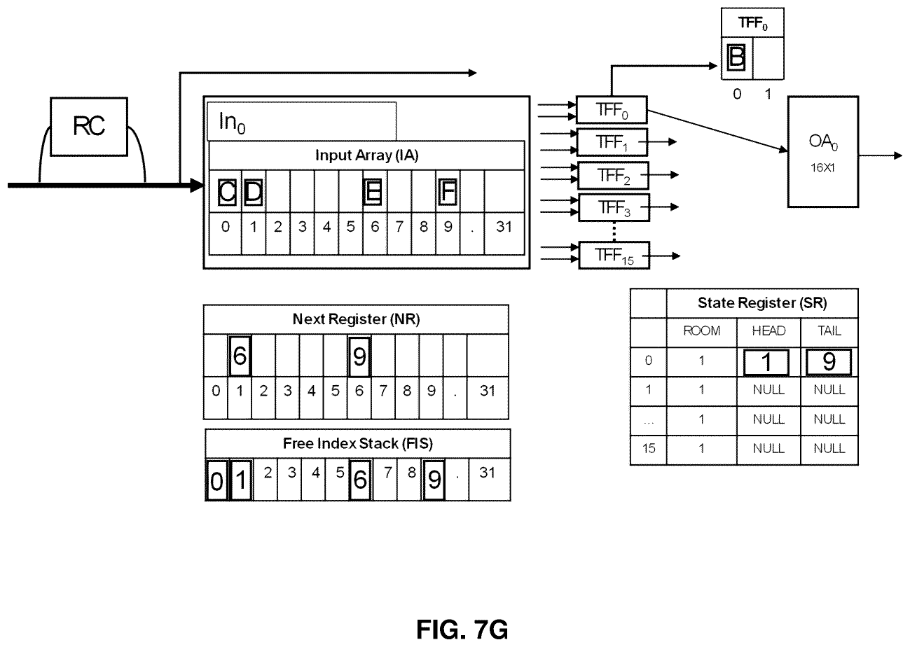

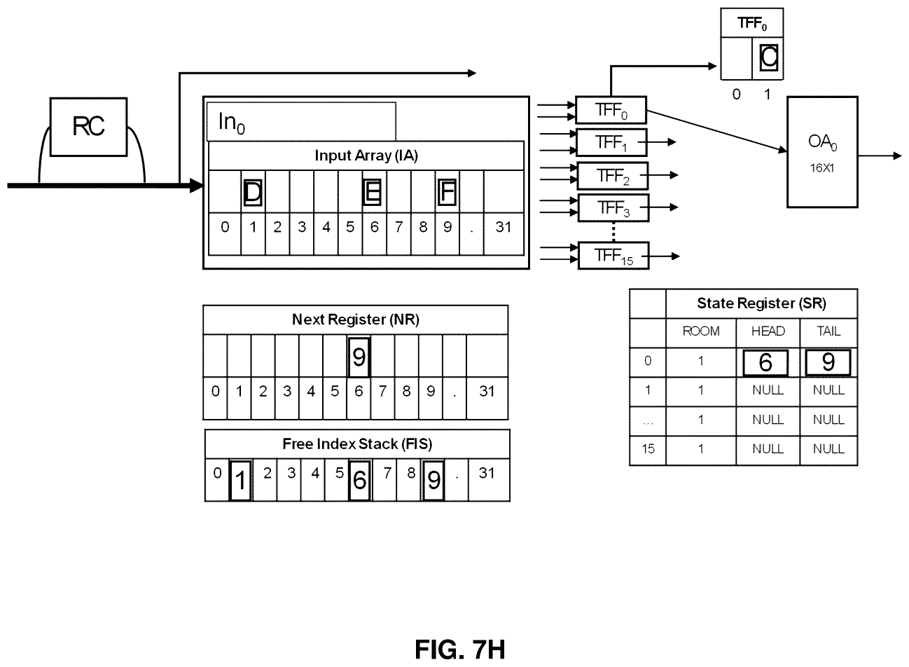

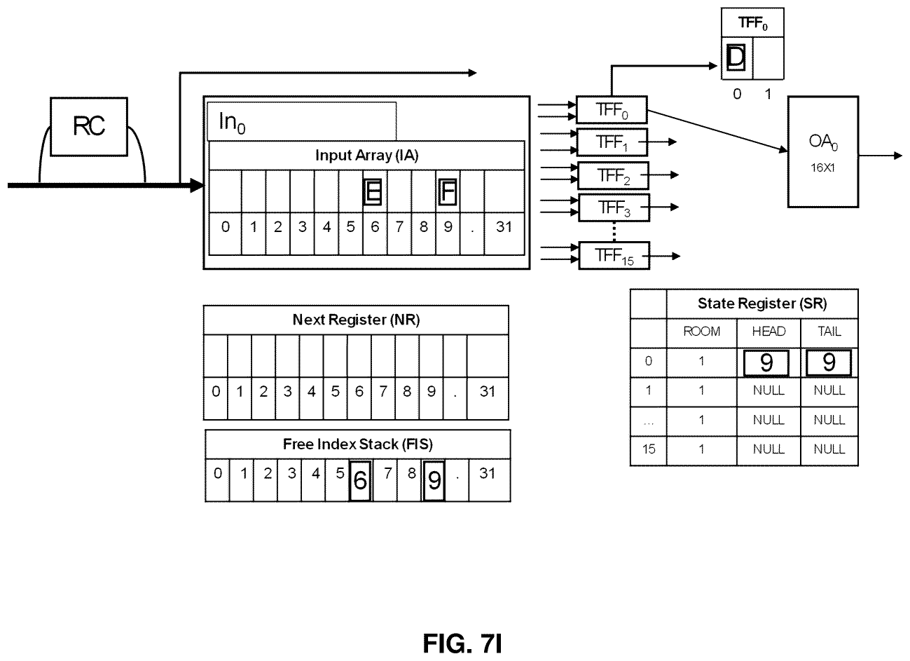

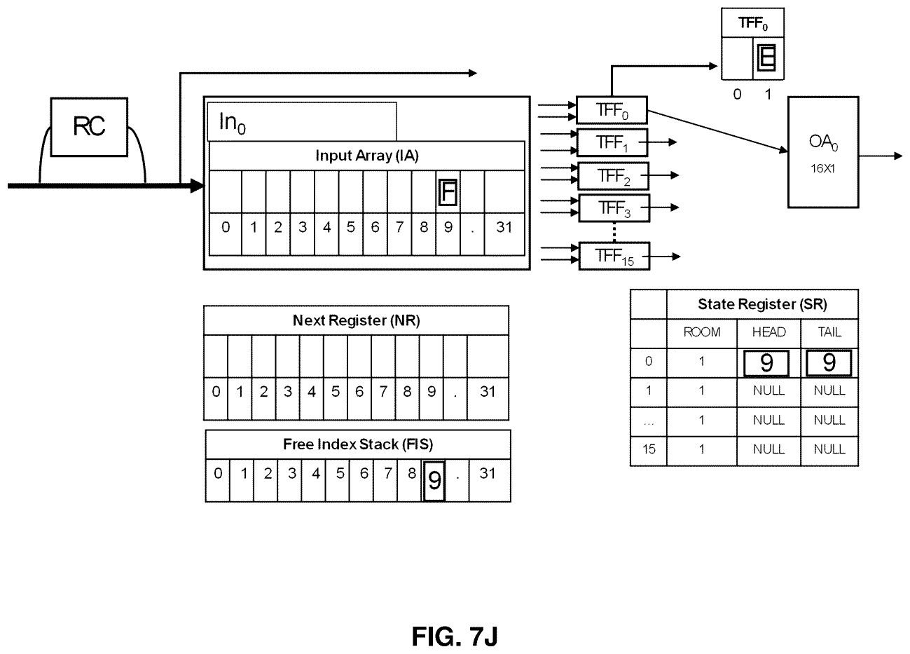

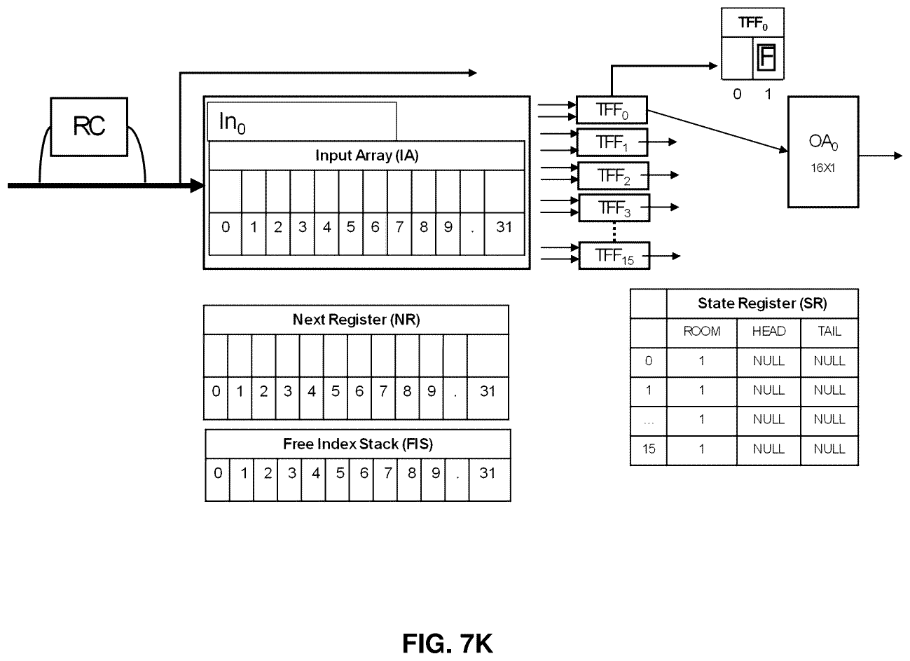

FIGS. 7A-7F depict example operations to load and release packets to arbitration for egress from an output port, where the packets are stored in a bypass buffer or input memory associated with an input port. FIG. 7A depicts availability of packets A-F for transmission. Bypass buffer is available for allocation of two packets. FIG. 7B depicts an example of allocation of packet A to a bypass buffer for output port 0 based on availability of space in the bypass buffer for output port 0. FIG. 7C depicts an example of allocation of packet B to the bypass buffer for output port 0 based on availability of space in the bypass buffer for output port 0.

FIG. 7C depicts an example of allocation of packet C into Input Memory (Input Array) for the input port based on unavailability of space in the bypass buffer for output port 0. FIS indicates that index 0 in input memory or array (IA) is available and packet C is allocated to the slot for index 0. An SR entry for output port 0 is updated to indicate that a head and tail of IA is 0 and 0, respectively.

FIG. 7D depicts an example of allocation of packet D. FIS indicates that index 1 in IA is available and packet D is allocated to the slot in IA for index 1. NR is updated to indicate a value of 1 to indicate that a packet that follows packet C, packet D, is to be accessed from a slot in IA allocated for index 1. An SR entry for output port 0 is updated to indicate that a head and tail of IA is 0 and 1, respectively.

FIG. 7E depicts an example of allocation of packet E. FIS indicates that index 6 in IA is available and packet D is allocated to the slot in IA for index 6. NR is updated to indicate a value of 6 to indicate that a packet that follows packet D, packet E, is to be accessed from a slot in IA allocated for index 6. An SR entry for output port 0 is updated to indicate that a head and tail of IA is 0 and 6, respectively.

FIG. 7F depicts an example of allocation of packet F. FIS indicates that index 9 in IA is available and packet F is allocated to the slot for index 9. NR is updated to indicate a value of 9 to indicate that a packet that follows packet E, packet F, is to be accessed from a slot allocated for index 9. An SR entry for output port 0 is updated to indicate that a head and tail of IA is 0 and 9, respectively.

FIGS. 7G-7K depict example operations to egress packets from the bypass buffer for output port 0 and input memory. FIG. 7G depicts an example of egress of packet B from the bypass buffer for output port 0 to an arbiter for output port 0. NR is updated to release a value of 1 in index 0 to indicate packet C is next to be released from the IA to the bypass buffer for output port 0. As there is no change to the packets stored in IA, an SR entry for output port 0 remains a head and tail of IA is 0 and 9, respectively.

FIG. 7H depicts an example of egress of packet C from the bypass buffer. Packet C is loaded from the bypass buffer to an arbiter for output port 0. NR is updated to release a value of 6 in index 1 to indicate packet D is next to be released from the IA to the bypass buffer for output port 0. SR is updated to indicate that a head and tail of IA is 6 and 9, respectively.

FIG. 7I depicts an example of egress of packet D from bypass buffer to an arbiter for output port 0. Packet D is loaded from the bypass buffer to an arbiter for output port 0. NR is updated to release a value of 9 in index 6 to indicate packet E is next to be released from the IA to the bypass buffer for output port 0. SR is updated to indicate that a head and tail of IA is 9 and 9, respectively.

FIG. 7J depicts an example of egress of packet E from bypass buffer. Packet E is loaded from the bypass buffer to an arbiter for output port 0. NR is not updated as the packet because there is no packet after packet F to be released from the IA. As there is no change to the packets stored in IA, an SR entry for output port 0 remains a head and tail of IA is 0 and 9, respectively.

FIG. 7K depicts an example of egress of packet F from bypass buffer. Packet F is loaded from the bypass buffer to an arbiter for output port 0. SR is updated to indicate that a head and tail of IA is null and null, respectively, as there is no packet allocated to the IA.

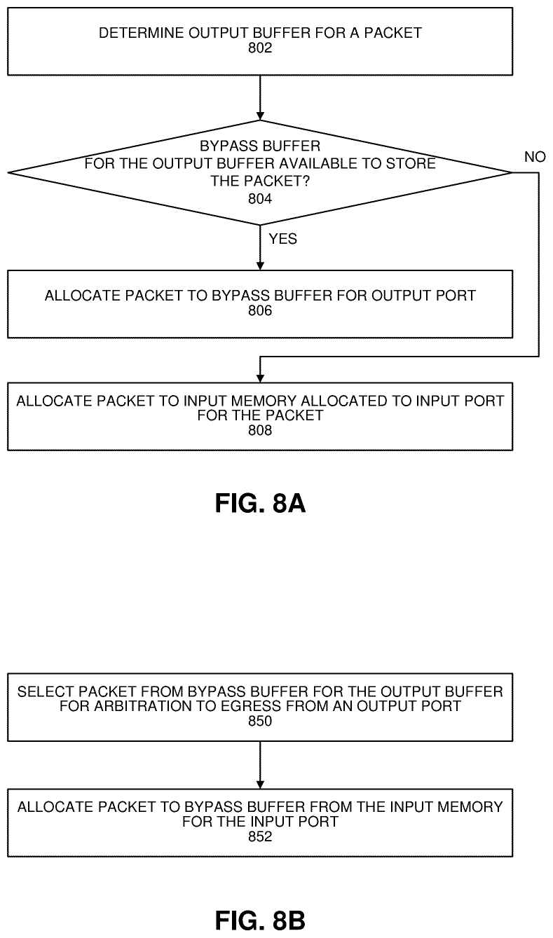

FIG. 8A depicts an example process. The process can be performed by a router or switch in some examples. At 802, an output port for a packet received at an input port can be determined. At 804, a determination can be made as to whether there is space in a bypass buffer. At 806, based on availability to store the packet into a bypass buffer for the output port, the switch can store the packet into the bypass buffer. At 808, based on unavailability to store the packet into a bypass buffer for the output port, the switch can store the packet into an input memory for the input port.

FIG. 8B depicts an example process. The process can be performed by an arbiter for an output port of a router or switch in some examples. At 850, based on a packet allocated in a bypass buffer, an arbiter can select the packet for arbitration for egress from the switch. At 852, based on availability for allocation of a packet in the bypass buffer, a second packet allocated in the input memory can be allocated in the bypass buffer for the output switch.

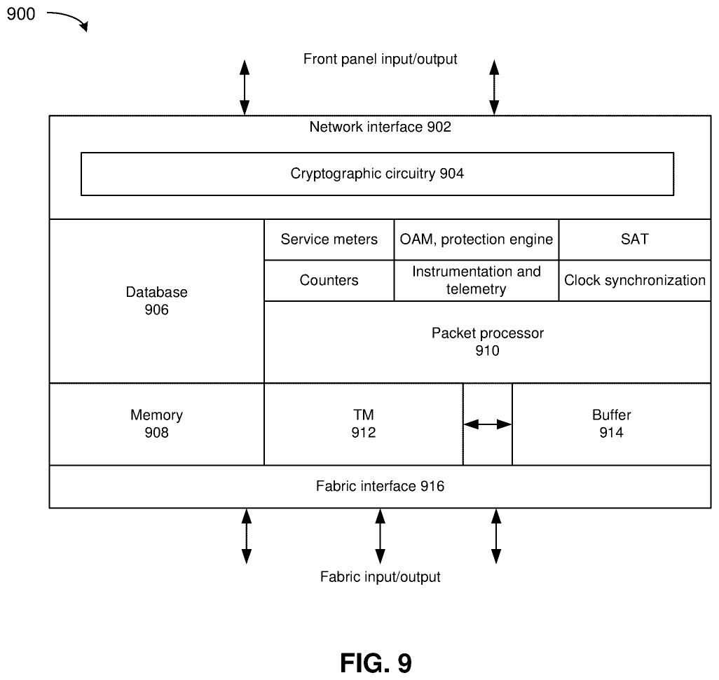

FIG. 9 depicts an example switch. Switch 900 can include circuitry and software described with respect to FIG. 1 to utilize a bypass buffer for a particular output port to buffer packets before arbitration to egress from the output port. Switch 900 can include a network interface 900 that can provide an Ethernet consistent interface. Network interface 900 can support for 25 GbE, 50 GbE, 100 GbE, 200 GbE, 400 GbE Ethernet port interfaces. Cryptographic circuitry 904 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 906 can store a device's profile to configure operations of switch 900. Memory 908 can include High Bandwidth Memory (HBM) for packet buffering. Packet processor 910 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 910 can include one or more FPGAs. Buffer 914 can store one or more packets. Traffic manager (TM) 912 can provide per-subscriber bandwidth guarantees in accordance with service level agreements (SLAs) as well as performing hierarchical quality of service (QoS). Fabric interface 916 can include a serializer/de-serializer (SerDes) and provide an interface to a switch fabric.

For example, components of examples of switch 900 can be implemented in a switch system on chip (SoC) that includes at least one interface to other circuitry in a switch system. A switch SoC can be coupled to other devices in a switch system such as ingress or egress ports, memory devices, or host interface circuitry.

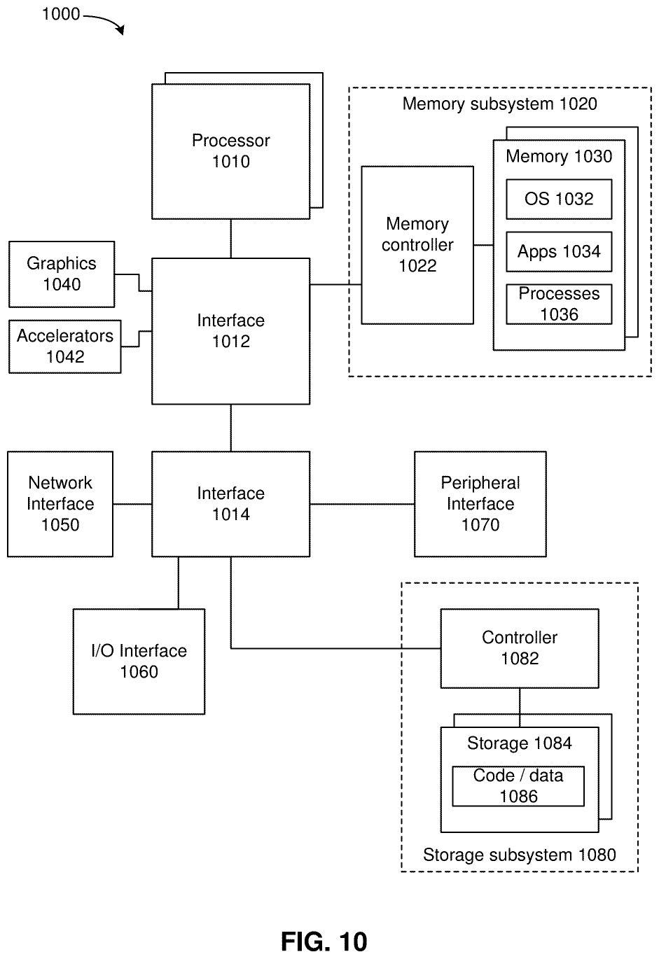

FIG. 10 depicts a system. In some examples, circuitry of network interface device can utilize a bypass buffer for a particular output port to buffer packets before arbitration to egress from the output port, as described herein. System 1000 includes processor 1010, which provides processing, operation management, and execution of instructions for system 1000. Processor 1010 can include any type of microprocessor, central processing unit (CPU), graphics processing unit (GPU), XPU, processing core, or other processing hardware to provide processing for system 1000, or a combination of processors. An XPU can include one or more of: a CPU, a graphics processing unit (GPU), general purpose GPU (GPGPU), and/or other processing units (e.g., accelerators or programmable or fixed function FPGAs). Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Graphics interface 1040 can provide an interface to graphics components for providing a visual display to a user of system 1000. In one example, graphics interface 1040 can drive a display that provides an output to a user. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a programmable or fixed function offload engine that can be accessed or used by a processor 1010. For example, an accelerator among accelerators 1042 can provide data compression (DC) capability, cryptography services such as public key encryption (PKE), cipher, hash/authentication capabilities, decryption, or other capabilities or services. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

Applications 1034 and/or processes 1036 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

In some examples, OS 1032, a system administrator, and/or orchestrator can configure network interface 1050 to perform operations described at least with respect to FIG. 1 or 9.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can receive data from a remote device, which can include storing received data into memory. In some examples, packet processing device or network interface device 1050 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 1000 includes one or more input/output (I/O) interface(s) 1060. I/O interface 1060 can include one or more interface components through which a user interacts with system 1000. Peripheral interface 1070 can include any hardware interface not specifically mentioned above. Peripherals refer generally to devices that connect dependently to system 1000.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. A non-volatile memory (NVM) device is a memory whose state is determinate even if power is interrupted to the device.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1000 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a network on chip (NoC) comprising: a first interface to a first input port; a second interface to a first output port; a third interface to a memory; and switch circuitry, coupled to the first interface, the second interface, and the third interface, wherein the switch circuitry is to: based on receipt of a packet at the first input port and based on allocation of a first memory region in the memory to the first input port: based on capability of a first buffer for the first output port to store the packet, store the packet into the first buffer and egress the packet from the first buffer to the first output port and based on incapability of the first buffer to store the packet, store the packet into the first memory region and associate the packet with the first buffer prior to egress from the first output port.

Example 2 includes one or more examples, wherein the first memory region comprises a single virtual channel for the first input port to multiple different output ports.

Example 3 includes one or more examples, and includes a fourth interface to a second output port, wherein the switch circuitry is to: based on receipt of a second packet at the first input port: based on capability of a second buffer for the second output port to store the second packet, store the second packet into the second buffer and egress the second packet from the second buffer to the second output port and based on incapability of the second buffer to store the second packet, store the second packet into the first memory region and associate the second packet with the second buffer prior to egress from the second output port.

Example 4 includes one or more examples, wherein multiple buffers are allocated to the first input port and wherein the multiple buffers are associated with different output ports.

Example 5 includes one or more examples, wherein the switch circuitry is to perform arbitration among the packet and packets from other input ports to identify a packet to egress from the first output port.

Example 6 includes one or more examples, and includes: a fourth interface to a second input port, wherein: based on receipt of a second packet at the second input port and based on allocation of a second memory region in the memory to the second input port: based on capability of a second buffer for the first output port to store the second packet, store the second packet into the second buffer and egress the second packet from the second buffer to the first output port and based on incapability of the second buffer to store the second packet, store the second packet into the second memory region and associate the second packet with the second buffer prior to egress from the first output port.

Example 7 includes one or more examples, and includes multiple levels of arbiters to arbitrate egress of packets, including the packet, from the first output port.

Example 8 includes one or more examples, and includes a method that includes: configuring one or more routers in a network to: based on receipt of a packet at a first input port and based on allocation of a first memory region in a memory to the first input port: based on capability of a first buffer for a first output port to store the packet, storing the packet into the first buffer and egress the packet from the first buffer to the first output port and based on incapability of the first buffer to store the packet, storing the packet into the first memory region and associating the packet with the first buffer prior to egress from the first output port.

Example 9 includes one or more examples, wherein the first memory region comprises a single virtual channel for the first input port to multiple different output ports.

Example 10 includes one or more examples, and includes based on receipt of a second packet at the first input port: based on capability of a second buffer for a second output port to store the second packet, store the second packet into a second buffer and egress the second packet from the second buffer to the second output port and based on incapability of the second buffer to store the second packet, storing the second packet into the first memory region and associating the second packet with the second buffer prior to egress of the second packet from the second output port.

Example 11 includes one or more examples, wherein multiple buffers are allocated to the first input port and wherein the multiple buffers are associated with different output ports.

Example 12 includes one or more examples, and includes performing arbitration among multiple packets, including the packet, to identify a packet to egress from the first output port.

Example 13 includes one or more examples, and includes based on receipt of a second packet at a second input port and based on allocation of a second memory region in the memory to the second input port: based on capability of a second buffer for the first output port to store the second packet, storing the second packet into the second buffer and egress the second packet from the second buffer to the first output port and based on incapability of the second buffer to store the second packet, storing the second packet into the second memory region and associating the second packet with the second buffer prior to egress of the second from the first output port.

Example 14 includes one or more examples, wherein the network comprises one or more of: a mesh, network on chip (NoC), or off-chip network.

Example 15 includes one or more examples, and includes at least one computer-readable medium comprising instructions stored thereon, that if executed by one or more circuitry of a router, cause the one or more circuitry of the router to: based on receipt of a packet at a first input port and based on allocation of a first memory region in a memory to the first input port: based on capability of a first buffer for a first output port to store the packet, store the packet into the first buffer and egress the packet from the first buffer to the first output port and based on incapability of the first buffer to store the packet, store the packet into the first memory region and copy the packet stored in the first memory region to the first buffer prior to egress from the first output port.

Example 16 includes one or more examples, and includes instructions stored thereon, that if executed by one or more circuitry of the router, cause the one or more circuitry of the router to: based on receipt of a second packet at the first input port: based on capability of a second buffer for a second output port to store the second packet, store the second packet into a second buffer and egress the second packet from the second buffer to the second output port and based on incapability of the second buffer to store the second packet, store the second packet into the first memory region and copy the second packet stored in the first memory region to the second buffer prior to egress from the second output port.

Example 17 includes one or more examples, wherein multiple buffers are allocated to the first input port and wherein the multiple buffers are allocated to different output ports.

Example 18 includes one or more examples, and includes instructions stored thereon, that if executed by the one or more circuitry of the router, cause the one or more circuitry of the router to: perform arbitration among multiple buffers to identify a packet to egress from the first output port.

Example 19 includes one or more examples, and includes instructions stored thereon, that if executed by one or more circuitry of the router, cause the one or more circuitry of the router to: based on receipt of a second packet at a second input port and based on allocation of a second memory region in the memory to the second input port: based on capability of a second buffer for the first output port to store the second packet, store the second packet into the second buffer and egress the second packet from the second buffer to the first output port and based on incapability of the second buffer to store the second packet, store the second packet into the second memory region and copy the second packet stored in the second memory region to the second buffer prior to egress from the first output port.

Example 20 includes one or more examples, wherein the first memory region comprises entries allocated for particular message types.

1. An apparatus comprising:
a network on chip (NoC) comprising:
a first interface to a first input port;
a second interface to a first output port;
a third interface to a memory; and
switch circuitry, coupled to the first interface, the second interface, and the third interface, wherein the switch circuitry is to:
based on receipt of a packet at the first input port and based on allocation of a first memory region in the memory to the first input port:
based on capability of a first buffer for the first output port to store the packet, store the packet into the first buffer and egress the packet from the first buffer to the first output port and
based on incapability of the first buffer to store the packet, store the packet into the first memory region and associate the packet with the first buffer prior to egress from the first output port.

2. The apparatus of claim 1, wherein the first memory region comprises a single virtual channel for the first input port to multiple different output ports.

3. The apparatus of claim 1, comprising a fourth interface to a second output port, wherein the switch circuitry is to:
based on receipt of a second packet at the first input port:
based on capability of a second buffer for the second output port to store the second packet, store the second packet into the second buffer and egress the second packet from the second buffer to the second output port and
based on incapability of the second buffer to store the second packet, store the second packet into the first memory region and associate the second packet with the second buffer prior to egress from the second output port.

4. The apparatus of claim 1, wherein multiple buffers are allocated to the first input port and wherein the multiple buffers are associated with different output ports.

5. The apparatus of claim 1, wherein the switch circuitry is to perform arbitration among the packet and packets from other input ports to identify a packet to egress from the first output port.

6. The apparatus of claim 1, comprising: a fourth interface to a second input port, wherein:
based on receipt of a second packet at the second input port and based on allocation of a second memory region in the memory to the second input port:
based on capability of a second buffer for the first output port to store the second packet, store the second packet into the second buffer and egress the second packet from the second buffer to the first output port and
based on incapability of the second buffer to store the second packet, store the second packet into the second memory region and associate the second packet with the second buffer prior to egress from the first output port.

7. The apparatus of claim 1, comprising:
multiple levels of arbiters to arbitrate egress of packets, including the packet, from the first output port.

8. A method comprising:
configuring one or more routers in a network to:
based on receipt of a packet at a first input port and based on allocation of a first memory region in a memory to the first input port:
based on capability of a first buffer for a first output port to store the packet, storing the packet into the first buffer and egress the packet from the first buffer to the first output port and
based on incapability of the first buffer to store the packet, storing the packet into the first memory region and associating the packet with the first buffer prior to egress from the first output port.

9. The method of claim 8, wherein the first memory region comprises a single virtual channel for the first input port to multiple different output ports.

10. The method of claim 8, comprising:
based on receipt of a second packet at the first input port:
based on capability of a second buffer for a second output port to store the second packet, store the second packet into a second buffer and egress the second packet from the second buffer to the second output port and
based on incapability of the second buffer to store the second packet, storing the second packet into the first memory region and associating the second packet with the second buffer prior to egress of the second packet from the second output port.

11. The method of claim 8, wherein multiple buffers are allocated to the first input port and wherein the multiple buffers are associated with different output ports.

12. The method of claim 8, comprising:
performing arbitration among multiple packets, including the packet, to identify a packet to egress from the first output port.

13. The method of claim 8, comprising:
based on receipt of a second packet at a second input port and based on allocation of a second memory region in the memory to the second input port:
based on capability of a second buffer for the first output port to store the second packet, storing the second packet into the second buffer and egress the second packet from the second buffer to the first output port and
based on incapability of the second buffer to store the second packet, storing the second packet into the second memory region and associating the second packet with the second buffer prior to egress of the second from the first output port.

14. The method of claim 8, wherein the network comprises one or more of: a mesh, network on chip (NoC), or off-chip network.

15. At least one computer-readable medium comprising instructions stored thereon, that if executed by one or more circuitry of a router, cause the one or more circuitry of the router to:
based on receipt of a packet at a first input port and based on allocation of a first memory region in a memory to the first input port:
based on capability of a first buffer for a first output port to store the packet, store the packet into the first buffer and egress the packet from the first buffer to the first output port and
based on incapability of the first buffer to store the packet, store the packet into the first memory region and copy the packet stored in the first memory region to the first buffer prior to egress from the first output port.

16. The computer-readable medium of claim 15, comprising instructions stored thereon, that if executed by one or more circuitry of the router, cause the one or more circuitry of the router to:
based on receipt of a second packet at the first input port:
based on capability of a second buffer for a second output port to store the second packet, store the second packet into a second buffer and egress the second packet from the second buffer to the second output port and
based on incapability of the second buffer to store the second packet, store the second packet into the first memory region and copy the second packet stored in the first memory region to the second buffer prior to egress from the second output port.

17. The computer-readable medium of claim 15, wherein multiple buffers are allocated to the first input port and wherein the multiple buffers are allocated to different output ports.

18. The computer-readable medium of claim 15, comprising instructions stored thereon, that if executed by the one or more circuitry of the router, cause the one or more circuitry of the router to:
perform arbitration among multiple buffers to identify a packet to egress from the first output port.

19. The computer-readable medium of claim 16, comprising instructions stored thereon, that if executed by one or more circuitry of the router, cause the one or more circuitry of the router to:
based on receipt of a second packet at a second input port and based on allocation of a second memory region in the memory to the second input port:
based on capability of a second buffer for the first output port to store the second packet, store the second packet into the second buffer and egress the second packet from the second buffer to the first output port and
based on incapability of the second buffer to store the second packet, store the second packet into the second memory region and copy the second packet stored in the second memory region to the second buffer prior to egress from the first output port.

20. The computer-readable medium of claim 16, wherein the first memory region comprises entries allocated for particular message types.
